(19) United States
(12) Patent Application Publication
(10) Pub. No.: US 2005/0262040 A1
(43) Pub. Date: Nov. 24, 2005

(54) Software Systems and Methods for Programmatically creating Graphical and Text Elements using OLE and/or Macro Functionality of Commercially Available Software Applications in the Background

(75) Inventor: Thomas Alan Levey, Arlington, TX (US)

Correspondence Address: Mr.Thomas Alan Levey, 2116 Hunter Place Lane, Arlington, TX, 76006, US

(73) Assignee: Mr. Thomas Alan Levey, Arlington, TX (US)

(21) Appl. No.: 10/908,641

(22) Filed: May 20, 2005

Related U.S. Application Data
(60) Provisional application No. 60/573,562, filed on May 21, 2004.

(51) Int. Cl. G06F 7/00

(52) U.S. Cl. 707/1

(57) ABSTRACT

A software system composed of methods, intended for use by organizations ranging from in-house corporate marketing research and finance departments to third party market research agencies and consultancies that produce formal reports using graphs, charts, tables, drawing objects and textboxes to describe data collected from various sources. The objective of the system is to automate the process for producing these report elements which are typically generated by pre-processing the data and hand-entering and/or cutting-and-pasting the results manually into software that is used for creating these types of elements (spreadsheet, word processing or presentation applications). This manual process is both time-consuming and fraught with potential errors. With the advent of higher power personal computers and OEM (Original Equipment Manufacturer) software applications that allow third party software developers to control the functionality of the OEM software via OLE run in the background with little or no user interaction with the OEM software, it is now possible to automate these laborious tasks.

### FIELD OF THE INVENTION

The present invention relates generally to using software to automate manually intensive computer related tasks. More specifically, the present invention is methods for using the object linking and embedding (OLE) functionality of commercially available, OEM spreadsheet, word processing and presentation software to automate the process of creating graphs and tables in formal reports from various data sources.

### BACKGROUND OF THE INVENTION

The reporting of data stored on computer systems has improved over the years, but the process of building graphs and tables for formal reports is still a predominately manual sequence of steps. In general, analysts and other business people must first pre-process the data using specialized software for calculating the desired result that will be shown in the graph or table, then create the graph or table (typically using a different software application requiring hand-entry of the aforementioned calculations) and finally, moving the graphs and tables into software programs designed to create the report.

Thus, even though this process began with data in an electronic format, utilizing disassociated software applications requires that the data be manually moved via cutting-and-pasting or hand entering after each processing step. This situation exists because there is no single software application that can a) perform every step needed to complete all the tasks and b) for portability, the final report must be in a universally available software application, which would mitigate the usefulness of a proprietary system that combines all of these functions.

The end result is that creating graphs and tables from electronic data for formal reports is a laborious task. With the advent of more powerful personal computers, it is now possible to fully utilize the object linking and embedding (OLE) functionality exposed by third party (OEM) software applications that are employed throughout this reporting process. These include: spreadsheet, word processing, presentation and statistical software applications.

In addition, the robust nature of OLE allows graphs, tables, textboxes and other graphical elements to be automated as well, which saves the average computer user even more time and allows them to produce output which they may not have been able to accomplished without help.

There is currently a vast body of software sometimes referred to as application add-ins in which the authors of the software use commercially available, third party OEM macros and/or OLE functionality to enhance the usefulness of the original OEM application. This invention appears to be the first commercial use of OLE to tie several OEM software packages together via a highly defined process that involves data, graphical elements (graphs, charts, tables, textboxes and drawing objects) and formal reporting of the data. This invention is not an add-in because it controls the OEM software in the background with very limited interaction by the user. Add-ins, on the other hand, typically add a custom toolbar to the OEM software application for performing tasks while the user interacts with the OEM software directly.

### SUMMARY OF THE INVENTION

According to one embodiment, the present invention is directed to providing the methods of a computer system for use by organizations ranging from in-house corporate market research and finance departments to market research agencies and other consultancies that produce formal reports using graphs, charts, tables, drawing objects and textboxes to describe data collected from various sources. The invention includes methods to utilize the object linking and embedding (OLE) functionality of software applications sold commercially by third party, original equipment manufacturers (OEM) in the background to automate the process of building formal report elements like graphs, tables, textboxes and drawing objects from electronically stored data sets.

In addition, the present invention has means for importing data stored in OEM software using the OLE functionality of the software and applying data definitions based on the source of the data. This imported data is further processed by methods that provide a graphical user interface (GUI) for creating specifications defining what calculation methods and graph, table or textbox options are applied using the OLE functionality of third party, commercially available software. Specifications are further defined by methods designed to size, position and place the resulting graphs, tables and textboxes in a third party reporting application. Ease-of-use methods including imported data augmentation, user-defined definitions for dataset elements and specifications, and automated reporting of statistical calculations are also incorporated into this invention.

### BRIEF DESCRIPTION OF THE DRAWINGS

Other aspects and advantages of the present invention will become apparent upon reading the following detailed description and upon reference to the drawings in which:

FIG. 1—is a block diagram illustrating the overall process this invention utilizes from data importation to specification creation and positioning.

FIG. 2—is an example of a GUI screen according to a current embodiment of the invention used for the importation of data stored in standardized OEM software applications.

FIG. 3.a and 3.b—are examples of GUI screens for defining imported data characteristics. Datasets are first analyzed after being imported to apply pre-defined characteristics of data used for specific formal reports like market research and financial analysis. Users can then further define the data by providing column and value labels (300 and 301) and indicate the type and other options for the specific type of data being processed (302).

FIG. 4.a and 4.b—are examples of a GUI screen according to a current embodiment of the invention. The 4.a GUI provides a single screen for the creation of a graph or table specification based on data labels, calculation methods (FIG. 4.b), graph (or table) settings (400) and other options (405). This screen may also take the form of step wizards and other partial screens that allow for the assignment or modification of specification options.

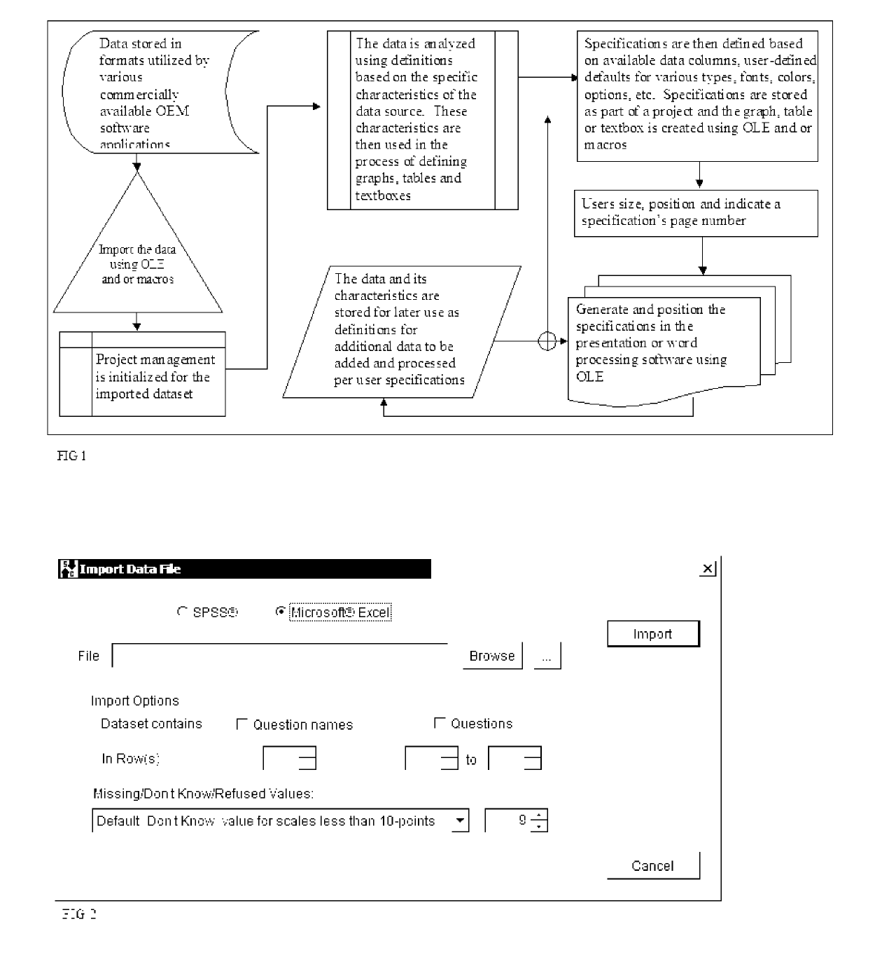

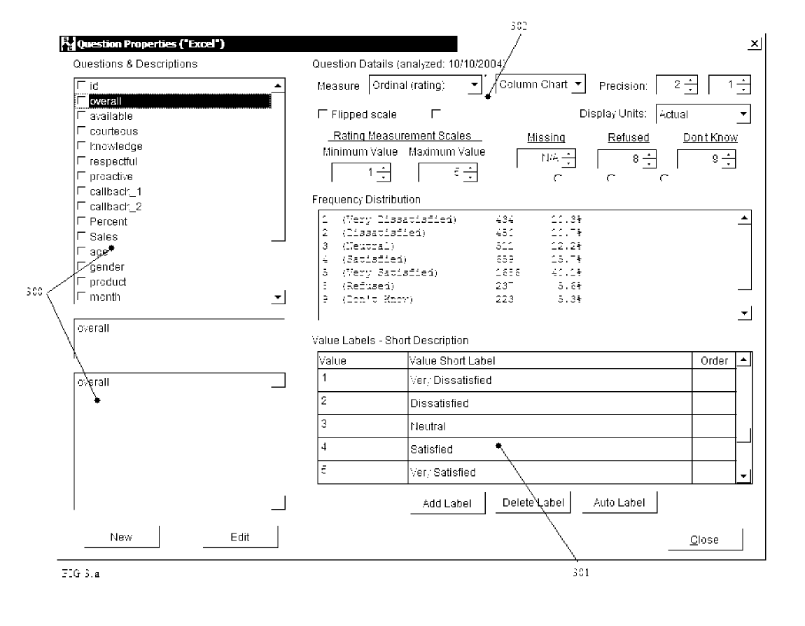

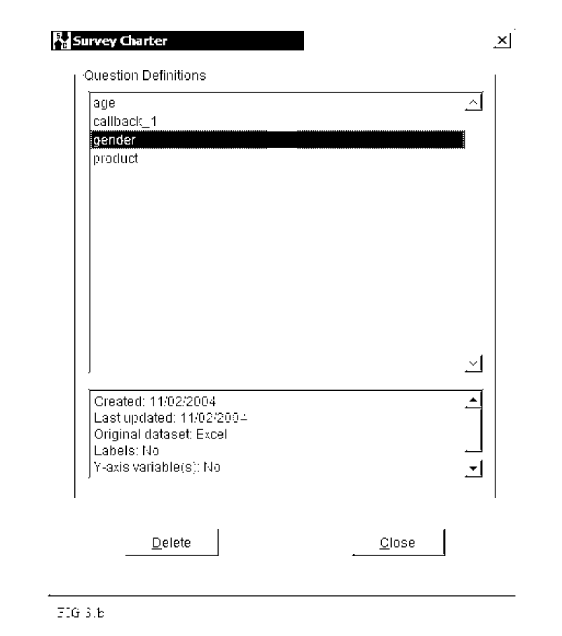

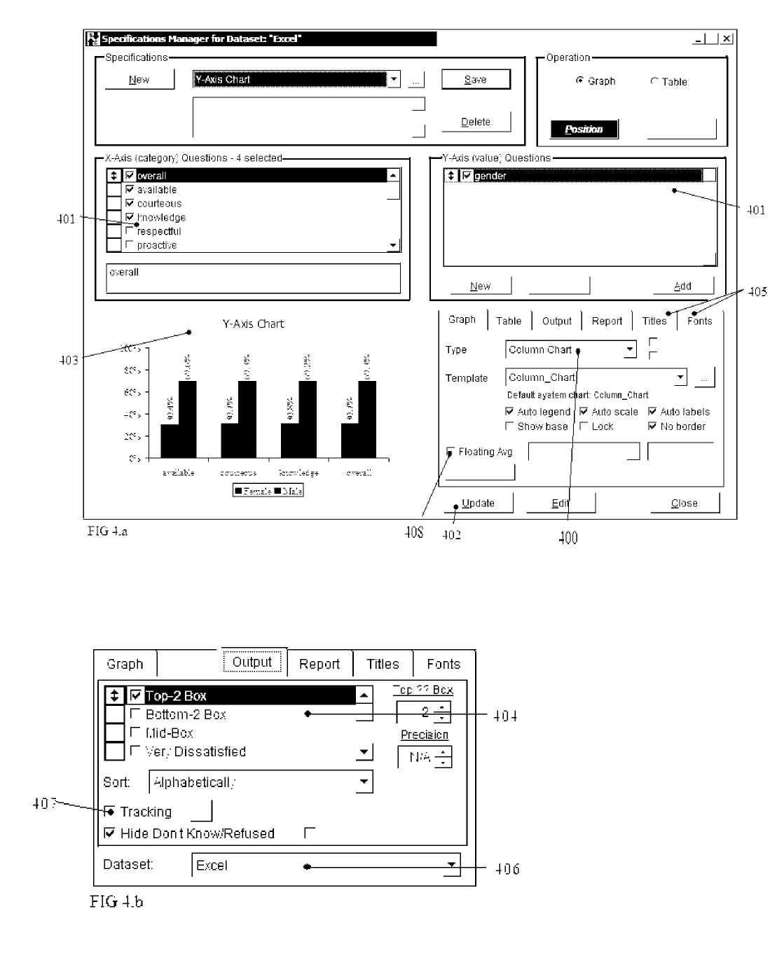

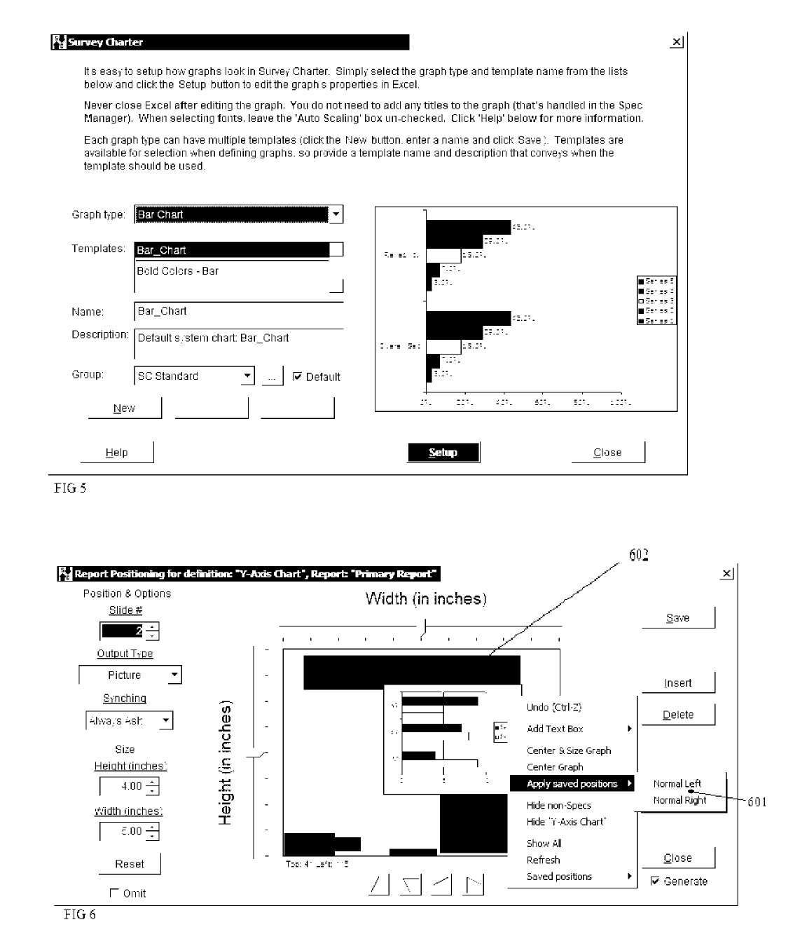

User-defined labels represent dataset columns (401), which the user can identify and select along with calculation methods (404) and other options like graph type (400) that define the specification. Updating the specification (402) creates the graph, table or textbox and provides a small representation of the finished product on this GUI screen (403). Datasets and specifications are uncoupled such that a specification can use any dataset imported into this invention (406)

In addition, an example of specialized computational processing (407) is the selection of a longitudinal tracking calculation option based on time stamps for individual records in the data. Programmatically adding drawing objects like lines and textbox shapes is illustrated by the floating average option (408), which stretches a straight line across a column graph at the exact position on the y-axis to represent the average of a selected data element.

FIG. 5—is an example of a GUI screen for managing user-defined graph template definitions that can be applied during the creation of a graph specification

FIG. 6—is an example of a GUI screen according to a current embodiment of the invention. Graph, table and textbox specifications are sized, positioned and placed on specific pages using this GUI. User-defined positioning (601) and existing graphic elements on the report page (602) enhance ease-of-use.

1. A computer software program which comprises:
Methods to import data that is saved in third party commercially available OEM software using the object linking and embedding (OLE) and/or macro functionality of that software in the background and with no interaction with the OEM software by the user;
Methods to store and configure the imported data using commercially available database software systems;
Methods to augment the stored data for use in graphs, tables and textboxes.

2. A computer software program which comprises:
Methods to create graph, chart, table and textbox specifications that define the calculations to be applied to stored datasets and define the graph, chart, table, textbox and drawing object types, formats and other ancillary options;
Methods for calculating standard, complex, longitudinal and filtered results within the dataset in order to accurately plot the data on a graph/chart or display calculated values in table cells or draft text coupled with calculated results in textboxes;
Methods for applying data calculations for the creation of graphs, charts, tables and textboxes in third party commercially available software from the graph, table and textbox specifications using the aforementioned third party software's object linking and embedding (OLE) and/or macro functionality in the background and with very limited interaction with the OEM software by the user;
Methods for sizing, locating, positioning and placing the graphs, tables and textboxes in a third party commercially available word processing or presentation software program using same said software program's OLE and/or macro functionality in the background and with no interaction with the OEM software by the user.

3. A computer software program that comprises methods to manage and control multiple third party, commercially available OEM software applications simultaneously using the exposed OLE functionality of the OEM software applications in the background such that the user has limited or no interaction with the OEM software.

4. A software system, according to claim 3, further comprising of methods to facilitate the process of importing specific datasets and creating graphs, charts, tables, textboxes and drawing objects and sizing and placing these graphs, charts, tables, textboxes and drawing objects in commercially available OEM software applications for formal reporting.

5. A software system, according to claim 1, further comprising of methods for recognizing and applying data definitions to input datasets that are created for a specific purpose like market research, marketing analysis, financial analysis and the like.

6. A software system, according to claim 1, further comprising of methods for managing stored data by appending, replacing or enhancing the stored date with new data elements as needed.

7. A software system, according to claim 1, further being capable of storing user-defined dataset definitions for the importation of data.

8. A software system, according to claim 2, further comprising of methods for recognizing and applying data definitions based on input datasets that are created for a specific purpose like market research, marketing analysis, financial analysis and the like as this data pertains to calculation methods, graph types and ancillary options of graph, table and textbox specifications.

9. A software system, according to claim 2, further being capable of storing user-defined definitions that can be applied to specifications for graphs, tables, textboxes and drawing objects or sizing/positioning graphs, tables and textboxes for output to a report.

10. A software system, according to claim 2, further comprising of methods for the automation of adding graphical drawing objects like boxes, lines and arrows programmatically to graphs, tables and textboxes using OLE in the background with no interaction with the third party software by the user.

11. A software system, according to claim 2, further being capable of calculating univariate and multivariate statistics and graphically displaying the results of these statistical tests and statistical analyses in graphs, tables and textboxes.

12. A software system, according to claim 2, further comprising methods and graphical user interfaces (GUI) for managing projects, specifications, templates, definitions and datasets as the datasets pertain to the specifications.

13. A software system, according to claim 1, further comprising a graphic user interfaces configured and arranged to facilitate the importation of data stored in third party commercially available software systems and graphic user interfaces allowing the user to augment this data as necessary.

14. A software system, according to claim 2, further comprising graphic user interfaces configured and arranged to facilitate the creation, modification and deletion of the graph, table and textbox specifications, and the sizing, locating and positioning of the graphs, tables and textboxes.
